(19) United States
(12) Patent Application Publication
(10) Pub. No.: US 2015/0081068 A1
(43) Pub. Date: Mar. 19, 2015

(54) METHOD FOR SYNCHRONIZING AUDIO PLAYBACK OF PLURAL PLAYING DEVICES AND AUDIO PLAYBACK SYSTEM

(71) Applicant: PRIMAX ELECTRONICS LTD., Neihu (TW)

(72) Inventor: Ting-Yuan Cheng, Neihu (TW)

(73) Assignee: PRIMAX ELECTRONICS LTD., Neihu (TW)

(21) Appl. No.: 14/084,470

(22) Filed: Nov. 19, 2013

(30) Foreign Application Priority Data
Sep. 18, 2013 (TW) 102133844

(51) Int. Cl. G06F 17/30

(52) U.S. Cl. CPC G06F 17/3074
USPC 700/94

(57) ABSTRACT

A method for synchronizing audio playback includes following steps. Firstly, a first playing device is set as a master playing device. Then, a second operation status of a second playing device is switched to a first operation status of the first playing device. In response to an action command, a first time information of the first playing device is transmitted to the second playing device. By comparing the first time information with a second time information of the second playing device, the second playing device and the first playing device start the audio playback. The first time information and the second time information are continuously compared with each other, and a playback progress of the second playing device is correspondingly adjusted. Consequently, the audio playback of the second playing device and the first playing device are synchronized.

### FIELD OF THE INVENTION

The present invention relates to a method for synchronizing audio playback of plural playing devices and an audio playback system, and more particularly to a method for synchronizing audio playback of plural playing devices and an audio playback system that comply with a Digital Living Network Alliance (DLNA) protocol.

### BACKGROUND OF THE INVENTION

The Digital Living Network Alliance (DLNA) is an alliance organization that is composed by the manufacturers of consumer electronics products, mobile phones and computers. The DLNA is responsible for defining unified transmission specifications to allow a variety of products from different manufacturers to communicate with each other. Consequently, the video and audio devices that comply with the DLNA protocol can be directly in communication with each other, make synchronization or even transfer data.

The devices that are operated under the DLNA environment include for example a digital media server (DMS), a digital media controller (DMC) and a digital media renderer (DMR). When plural digital media renderers, a digital media server and a digital media controller are in wireless communication with each other, the plural digital media renderers may receive audio data from the digital media server in a wireless transmission manner and play the audio data. However, the stability of wireless transmission is inferior to the stability of wired transmission. If the wireless transmission process is interfered, asynchronization between the plural digital media renderers may occur. Therefore, it is important to control and synchronize the audio playback of plural digital media renderers.

Hereinafter, a conventional synchronizing method will be illustrated with reference to FIGS. 1A and 1B. FIGS. 1A and 1B are a flowchart illustrating a conventional method for synchronizing audio playback of plural playing devices.

Conventionally, each media resource of the digital media server has a synchronization device list. The synchronization device list contains the device names and the IP addresses of all digital media renderers for synchronously playing the media resource.

A process of operating a digital media controller to control a digital media server to synchronize the audio playback of plural playing devices will be illustrated by referring to the flowchart of FIGS. 1A and 1B.

In the step 101, the user operates the digital media controller to issue a synchronization playback request to a specified media resource of the digital media server.

In the step 102, the digital media server searches a synchronization device list of the media resource.

In the step 103, the digital media server judges whether the synchronization device list is present. If the synchronization device list is present, the step 104 is performed. Whereas, if the synchronization device list is not present, the step 105 is performed.

In the step 104, the digital media server judges whether all digital media renderers shown in the synchronization device list are in an open and connection status. If any digital media renderer of the plural digital media renderers is not in the open and connection status, the step 106 is performed. Whereas, if all of the digital media renderers are in the open and connection status, the step 107 is performed.

In the step 105, the digital media server issues a “no synchronization device list” message to the digital media controller, and then the step 110 is performed.

In the step 106, the digital media renderers which are not in the open and connection status are deleted from the synchronization device list by the digital media server, and then the step 107 is performed.

In the step 107, a message about the available digital media renderers for synchronously playing the media resource is transmitted from the digital media server to the digital media controller, and then the step 108 is performed.

In the step 108, the digital media controller inquires the user whether the media resource is synchronously played or not. If the user decides to synchronously play the media resource, the step 109 is performed. Whereas, if the user decides not to synchronously play the media resource, the step 110 is performed.

In the step 109, the digital media controller issues a synchronization push command corresponding to the media resource to the digital media server, and the digital media server simultaneously pushes the media resource to the digital media renderers that are shown in the synchronization device list. Then, the step 111 is performed.

In the step 110, the media resource is not played, and the flowchart is ended.

In the step 111, the digital media renderers shown in the synchronization device list start acquiring the media resource.

In the step 112, while the digital media renderers shown in the synchronization device list acquires the media resource, the digital media renderers issue a “media resource ready” message to the digital media controller.

In the step 113, the digital media controller judges whether all digital media renderers shown in the synchronization device list are in a ready status. If the judging condition is satisfied, the step 114 is performed. Whereas, if the judging condition is not satisfied, the step 113 is performed again.

In the step 114, the digital media controller issues a synchronization command to all digital media renderers shown in the synchronization device list, and thus the media resource is played by these digital media renderers synchronously.

However, the conventional method for synchronizing the audio playback of plural playing devices still has some drawbacks. For example, in the step 114, after all digital media renderers shown in the synchronization device list are in the ready status, the digital media controller issues the synchronization command to these digital media renderers. In response to the synchronization command, these digital media renderers start to play the media resource synchronously. Due to transmission distance, transmission speed, network stability or other factors, the synchronization command from the digital media controller may fail to be transmitted to all digital media renderers simultaneously. That is, when one of the digital media renderers receives the synchronization command and starts the audio playback, the synchronization command is possibly not received by the other digital media renderers. Under this circumstance, the asynchronization between the plural digital media renderers occurs.

Therefore, there is a need of providing a method for synchronizing audio playback of plural playing devices in order to eliminate the above drawbacks.

### SUMMARY OF THE INVENTION

An object of the present invention provides a method for accurately synchronizing audio playback of plural playing devices and an audio playback system that comply with a Digital Living Network Alliance (DLNA) protocol.

In accordance with an aspect of the present invention, there is provided a method for synchronizing audio playback of plural playing devices. The plural playing devices include a first playing device and a second playing device. The method includes the following steps. In a step (A), the first playing device is set as a master playing device, wherein the first playing device is in a first operation status, and the second playing device is in a second operation status. In a step (B), the first playing device transmits the first operation status to the second playing device, so that the second operation status of the second playing device is switched to the first operation status. In a step (C), a digital media controller is used to transmit an action command. In a step (D), a first time information of the first playing device is transmitted to the second playing device after the playback command is received by the first playing device. In a step (E), the second playing device compares the first time information of the first playing device with a second time information of the second playing device, thereby controlling the second playing device and the first playing device to start the audio playback in response to the action command. In a step (F), the second playing device continuously receives the first time information of the first playing device and compares the first time information with the second time information after the first playing device and the second playing device start the audio playback, so that a playback progress of the second playing device is adjusted and the audio playback of the second playing device is synchronized with the audio playback of the first playing device.

In accordance with another aspect of the present invention, there is provided an audio playback system. The audio playback system includes a digital media controller, a first playing device, and a second playing device. The digital media controller sets a first playing device as a master playing device and issuing an action command. The first playing device includes a first digital media renderer control module and a first digital media controller control module. A first operation status and a first time information of the first playing device are transmitted from the first digital media renderer control module to a second playing device. The second playing device includes a second digital media renderer control module and a second digital media controller control module. The second digital media controller control module includes a synchronizing unit and a locked phase loop unit. The synchronizing unit receives the first operation status of the first playing device and switches a second operation status of the second playing device into the first operation status. In addition, the synchronizing unit compares the first time information of the first playing device with a second time information of the second playing device, thereby controlling audio playback of the first playing device and audio playback of the second playing device to be synchronously started in response to an action command. After the first playing device and the second playing device start the audio playback, the locked phase loop unit continuously receives the first time information of the first playing device and compares the first time information with the second time information. Consequently, a playback progress of the second playing device is adjusted and the audio playback of the second playing device is synchronized with the audio playback of the first playing device.

The above objects and advantages of the present invention will become more readily apparent to those ordinarily skilled in the art after reviewing the following detailed description and accompanying drawings, in which:

### BRIEF DESCRIPTION OF THE DRAWINGS

FIGS. 1A and 1B are a flowchart illustrating a conventional method for synchronizing audio playback of plural playing devices;

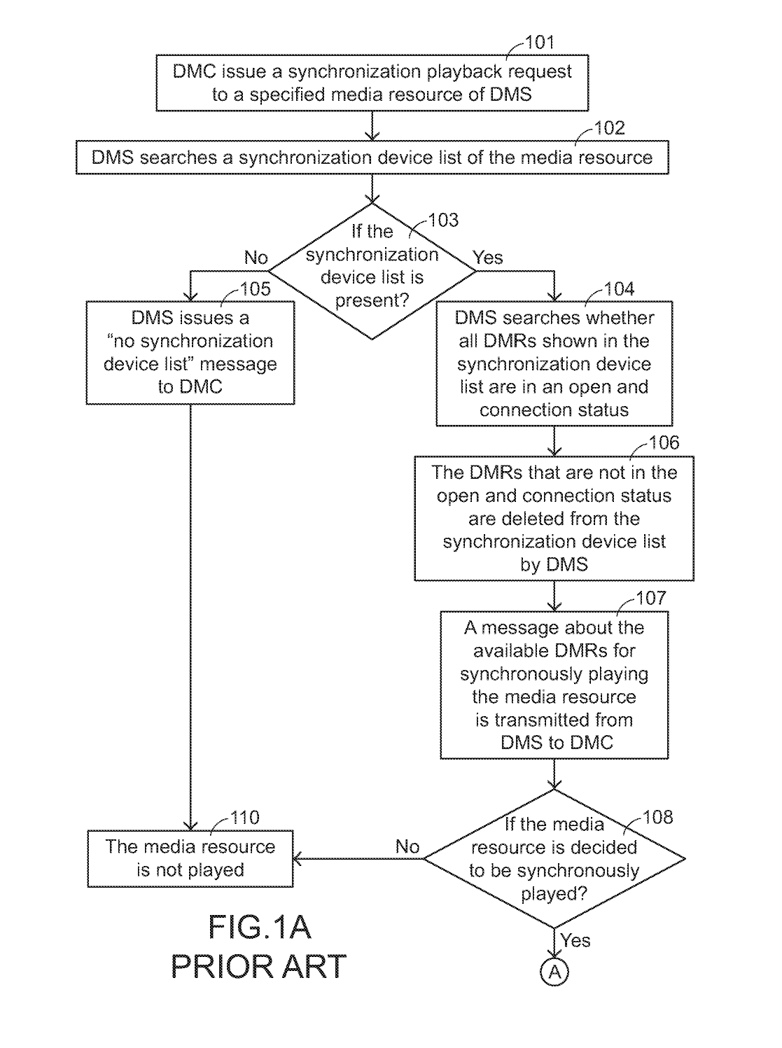

FIG. 2 is a schematic functional block diagram illustrating an audio playback system according to an embodiment of the present invention;

FIG. 3 is a flowchart illustrating a method for synchronizing audio playback of plural playing devices according to an embodiment of the present invention;

FIG. 4 schematically illustrates a playback group setting interface shown on the digital media controller of the audio playback system according to the embodiment of the present invention;

FIG. 5 is an operation interface of the digital media controller of the audio playback system according to the embodiment of the present invention; and

FIG. 6 is a schematic functional block diagram illustrating a locked phase loop unit of the second playing device of the audio playback system according to the embodiment of the present invention.

### DETAILED DESCRIPTION OF THE PREFERRED EMBODIMENT

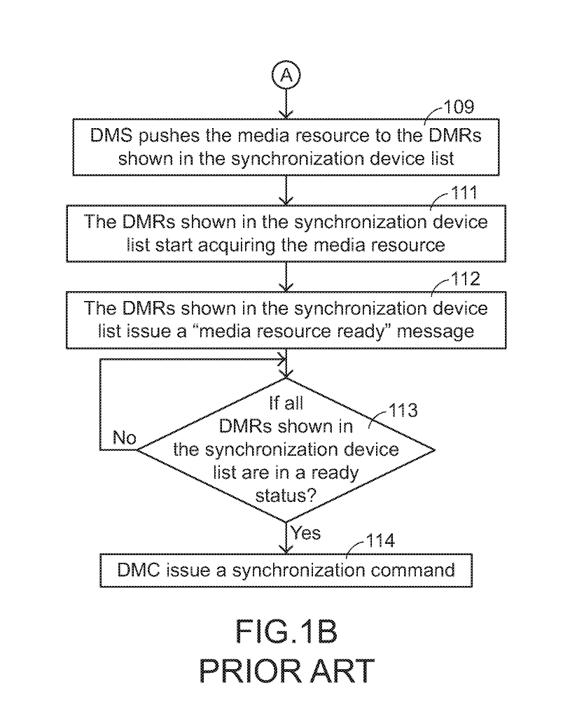

The present invention provides a method for synchronizing audio playback of plural playing devices and an audio playback system. Hereinafter, the audio playback system will be illustrated with reference to FIG. 2. FIG. 2 is a schematic functional block diagram illustrating an audio playback system according to an embodiment of the present invention.

As shown in FIG. 2, the audio playback system 2 comprises a digital media controller (DMC) 21, a first playing device 22, a second playing device 23, and a digital media server (DMS) 24. The first playing device 22 comprises a first digital media renderer (DMR) control module 221, a first digital media controller (DMC) control module 222, and a first playing module 223. The first DMC control module 222 comprises a synchronizing unit 2221 and a locked phase loop unit 2222. The second playing device 23 comprises a second digital media renderer (DMR) control module 231, a second digital media controller (DMC) control module 232, and a second playing module 233. The second DMC control module 223 comprises a synchronizing unit 2321 and a locked phase loop unit 2322.

The audio playback of one first playing device 22 and one second playing device 23 may be easily expanded to the audio playback of one first playing device 22 and plural second playing devices 23 while retaining the teachings of the invention. For succinctness and brevity, the operations of two playing devices are described in this embodiment. In practice, the audio playback system 2 may comprises two or more playing devices.

In this embodiment, the digital media server 24 provides at least one audio data of an audio file to the first playing device 22 in a wireless transmission manner. After the at least one audio data of the audio file is received by the first DMR control module 221 of the first playing device 22, the at least one audio data of the audio file is transmitted from the first playing device 22 to the second playing device 23 in the wireless transmission manner. Then, the at least one audio data of the audio file is played by the first playing module 223 of the first playing device 22 and the second playing module 233 of the second playing device 23.

However, due to the transmission instability or the initial status instability, the audio playback of the first playing device 22 and the audio playback of the second playing device 23 in the audio playback system 2 are not always synchronized. For solving this drawback, the first DMR control module 221 of the first playing device 22 and the second DMC control module 232 of the second playing device 23 are specially designed in order to control synchronization of the audio playback of the first playing device 22 and the audio playback of the second playing device 23.

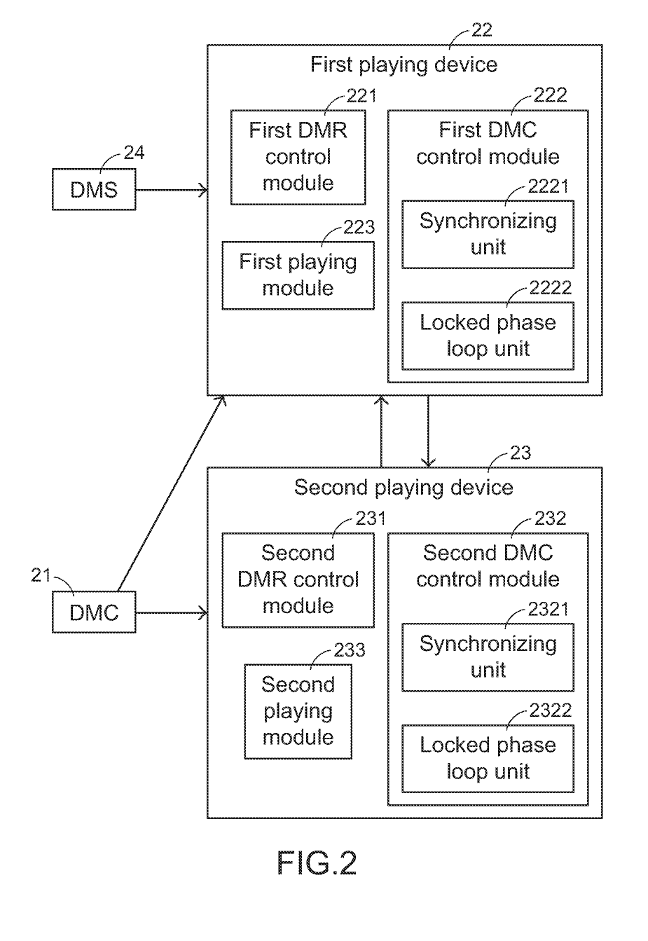

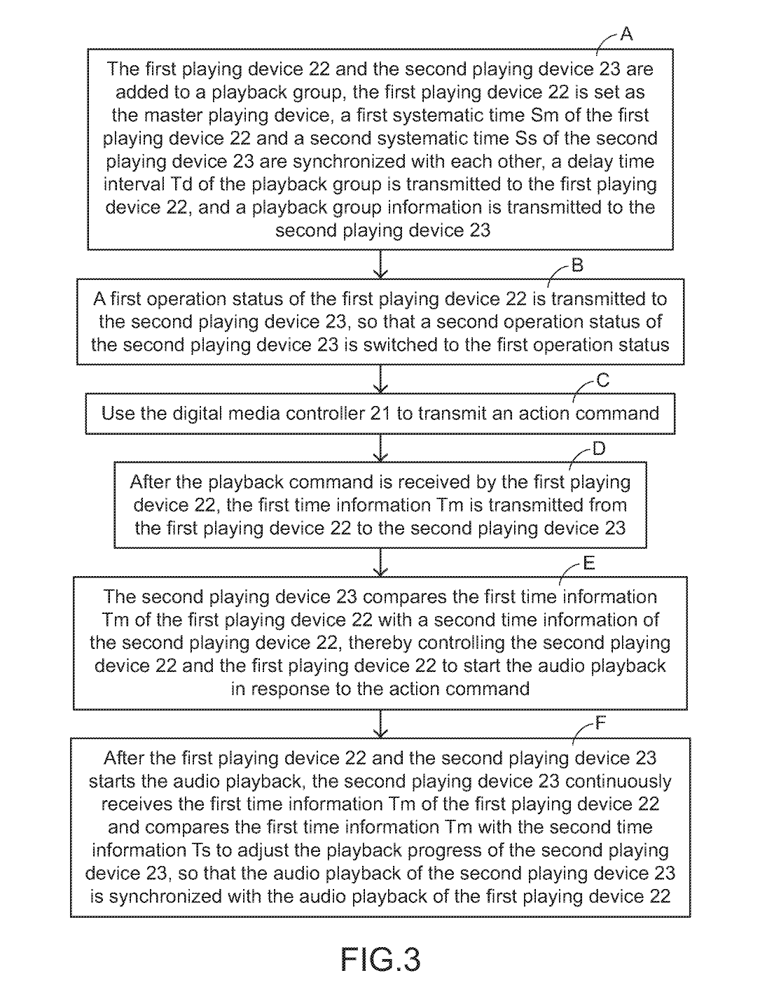

Hereinafter, a method for synchronizing audio playback of plural playing devices will be illustrated with reference to FIGS. 2, 3 and 4. FIG. 3 is a flowchart illustrating a method for synchronizing audio playback of plural playing devices according to an embodiment of the present invention. FIG. 4 schematically illustrates a playback group setting interface shown on the digital media controller of the audio playback system according to the embodiment of the present invention.

Firstly, in the step (A) as shown in FIG. 3, a playback group setting interface 25 as shown in FIG. 4 is created after an application program of the digital media controller 21 is opened by the user. In this embodiment, the digital media controller 21 is a mobile phone or a tablet computer. The application program is built in the digital media controller 21 or additionally installed by the user, but is not limited thereto. The contents of the playback group setting interface 25 as shown in FIG. 4 are presented herein for purpose of illustration and description only. That is, the contents of the playback group setting interface of the present invention are not restricted.

The playback group setting interface 25 comprises plural selective items about all DLNA-based playing devices in the same network domain. As shown in FIG. 4, the playback group setting interface 25 comprises plural selective items about the first playing device 22, the second playing device 23 and extra playing devices 26. Via the playback group setting interface 25, any playing device may be selected to be added to a playback group G, and a specified playing device may be set as a master playing device.

In this embodiment, the first playing device 22 and the second playing device 23 are selected to be added to the playback group G by the user, and the first playing device 22 is set as the master playing device. Since the first playing device 22 is the master playing device, the audio playback of the second playing device 23 will follow the audio playback of the first playing device 22.

It is noted that the user may add the extra playing devices 26 to the playback group G via the playback group setting interface 25 at any time point. The extra playing devices 26 added to the playback group G will be considered as the second playing devices 23, and the subsequent procedures will be performed.

After the settings of the playback group G are completed by the user, a first systematic time Sm of the first playing device 22 and a second systematic time Ss of the second playing device 23 are synchronized with each other. In addition, a delay time interval Td of the playback group G is transmitted from the digital media controller 21 to the first playing device 22 for subsequent uses. In an embodiment, the delay time interval Td is 10 seconds. It is noted that the delay time interval Td is an arbitrary time interval and is not limited to 10 seconds.

Moreover, in the step (A), a playback group information is further transmitted from the first DMR control module 221 of the first playing device 22 to the second DMR control module 231 of the second playing device 23. The playback information contains the information of all playing devices and the information of the master playing device.

Next, according to practical requirements, a first time information Tm, an audio data and an action command are transmitted from the first DMR control module 221 of the first playing device 22 (i.e. the master playing device) to the synchronizing unit 2321 of the second DMC control module 223. According to the first time information Tm and a second time information Ts of the second playing device 23, the process of synchronizing the audio playback is performed. The process of synchronizing the audio playback will be illustrated later.

In accordance with the present invention, the first time information Tm contains at least one of a current first systematic time Sm1, a first scheduled playback time Pm, a first playback progress Dm and a first initial playback time Cm. In addition, the second time information Ts contains at least one of a current second systematic time Ss1, a second scheduled playback time Ps, a second playback progress Ds and a second initial playback time Cs.

The current first systematic time Sm1 is the first systematic time Sm when the first time information Tm is transmitted from the first playing device 22. The current second systematic time Ss1 is the second systematic time Ss when the first time information Tm is received by the second playing device 23. The first scheduled playback time Pm is the first systematic time Sm when the scheduled playback of a specified audio file is started by the first playing device 22, and the second scheduled playback time Ps is the second systematic time Ss when the scheduled playback of the specified audio file is started by the second playing device 23. In accordance with the present invention, the ways of starting playback comprise a way of starting playback from the beginning and a way of starting playback from the pause. The first playback progress Dm indicates a time length of a specified audio file having been played by the first playing device 22, and the second playback progress Ds indicates the time length of the specified audio file having been played by the second playing device 23. The first initial playback time Cm is the first systematic time Sm when a specified audio file is started to be played by the first playing device 22 at a first time, and the second initial playback time Cs is the second systematic time Ss when the specified audio file is started to be played by the second playing device 23 at a first time.

Next, the step (B) is performed. Since the operation status of the first playing device 22 and the operation status of the second playing device 23 may be different before they are added to the playback group G, the step (B) of the flowchart of FIG. 3 has to be performed in order to synchronize the audio playback of the second playing device 23 with the audio playback of the master playing device (i.e. the first playing device 22). For example, before the first playing device 22 and the second playing device 23 are added to the playback group G, the first playing device 22 is in a first operation status, and the second playing device 23 is in a second operation status. Consequently, after the first operation status of the first playing device 22 is transmitted to the second playing device 23, the second operation status of the second playing device 23 is switched to the first operation status.

For example, the first operation status of the first playing device 22 may be one of a stop status, a pause status and a play status. Likewise, the second operation status of the second playing device 23 may be one of the stop status, the pause status and the play status.

In case that the first operation status of the first playing device 22 is the stop status, the detailed procedure of the step (B) will be illustrated as follows. In case that the first operation status of the first playing device 22 is the stop status, after the first operation status of the first playing device 22 is transmitted from the first DMR control module 221 to the synchronizing unit 2321 of the second DMC control module 232 of the second playing device 23, the second operation status of the second playing device 23 is directly switched to the stop status by the synchronizing unit 2321.

In case that the first operation status of the first playing device 22 is the pause status, the detailed procedure of the step (B) will be illustrated as follows. In case that the first operation status of the first playing device 22 is the pause status, the first operation status and also the first playback progress Dm are transmitted from the first DMR control module 221 of the first playing device 22 to the synchronizing unit 2321 of the second playing device 23. The first playback progress Dm indicates the time length of a specified audio file having been played by the first playing device 22 when the specified audio file is paused.

After the first operation status and the first playback progress Dm are received by the synchronizing unit 2321 of the second playing device 23, the second operation status of the second playing device 23 is switched to the pause status by the synchronizing unit 2321. Moreover, according to the settings of the synchronizing unit 2321, the second playback progress Ds leads the first playback progress Dm by a first predetermined time period. In an embodiment, the first predetermined time period is 1 second. For example, if the first playback progress Dm of the first playing device 22 indicates that the time length of the specified audio file having been played is 1 minute and 10 seconds. Consequently, according to the settings, the second playback progress Ds of the second playing device 23 indicates that the time length of the specified audio file having been played is 1 minute and 11 seconds.

In case that the first operation status of the first playing device 22 is the play status, the detailed procedure of the step (B) will be illustrated as follows. In case that the first operation status of the first playing device 22 is the play status, the first operation status and also the first playback progress Dm, the first initial playback time Cm and the current first systematic time Sm1 are transmitted from the first DMR control module 221 of the first playing device 22 to the synchronizing unit 2321 of the second playing device 23. The first initial playback time Cm is the first systematic time Sm when the playback of a specified audio file is started by the first playing device 22 at a first time. That is, the first initial playback time Cm is the first systematic time Sm when the playback of a first audio data of the specified audio file is started by the first playing device 22.

Then, the synchronizing unit 2321 calculates the sum of the first playback progress Dm and the first initial playback time Cm (i.e. Dm+Cm), and judges whether the sum (Dm+Cm) is equal to the current first systematic time Sm1.

If the sum (Dm+Cm) is equal to the current first systematic time Sm1, it means that the audio playback of the audio file has not been paused by the first playing device 22. Whereas, if the sum (Dm+Cm) is not equal to the current first systematic time Sm1, the audio playback of the audio file has ever been paused because a pause command has been received by the first playing device 22 or the network connection has been unstable.

As mentioned above, if the sum (Dm+Cm) is equal to the current first systematic time Sm1, the audio playback of the audio file C has not been paused by the first playing device 22. Consequently, when the first playback progress Dm and the first initial playback time Cm are received by the synchronizing unit 2321, the difference between the current second systematic time Ss1 and the first initial playback time Cm (i.e. Ss1−Cm) is equal to a new playback progress of the first playing device 22 corresponding to the current second systematic time Ss1. The new playback progress of the first playing device 22 is a first delayed playback progress Dm2 of the first playing device 22.

After the first delayed playback progress Dm2 is acquired, according to the settings of the synchronizing unit 2321, the second playback progress Ds leads the first delayed playback progress Dm2 by a second predetermined time period. The second predetermined time period is 3 seconds, but is not limited thereto. For example, if the first delayed playback progress Dm2 is 1 minute and 1 second, the second playback progress Ds is set as 1 minute and 4 seconds by the synchronizing unit 2321. Consequently, the second playing device 23 has sufficient time to determine the timing of starting playback of the audio file in order to synchronize the audio playback of the second playing device 23 with the first playing device 22.

Then, the synchronizing unit 2321 calculates the difference between the current second systematic time Ss1 and the first initial playback time Cm (i.e. Ss1−Cm), and calculates the difference between the second playback progress Ds and the first playback progress Dm (i.e. Ds−Dm).

Moreover, the sum of the difference (Sm1−Cm), the difference (Ds−Dm) and the first initial playback time Cm, i.e. (Sm1−Cm)+(Ds−Dm)+Cm, indicates the first systematic time Sm corresponding to the second playback progress Ds of the first playing device 22. Consequently, under control of the synchronizing unit 2321, the audio playback of the second playing device 23 is started at the time when the second systematic time Ss is larger than or equal to the above three terms. That is, the audio playback of the second playing device 23 is started at the time when Ss≧(Sm1−Cm)+(Ds−Dm)+Cm.

On the other hand, if the sum (Dm+Cm) is not equal to the current first systematic time Sm1, the audio playback of the audio file C has ever been paused by the first playing device 22 because a pause command has been received by the first playing device 22 or the network connection is unstable. Under this circumstance, the difference between the current second systematic time Ss1 when the information from the first playing device 22 is received and the current first systematic time Sm1 when the information is transmitted from the first playing device 22 to the second playing device 23 by the synchronizing unit 2321 (i.e. Ss1−Sm1) is calculated by the synchronizing unit 2321. Consequently, the transmission time period of transmitting the information from the first playing device 22 to the second playing device 23 is acquired.

Then, the sum of the first playback progress Dm and the transmission time period, i.e. (Ss1−Sm1)+Dm, is calculated by the synchronizing unit 2321. Consequently, when the information from the first playing device 22 is received by the second playing device 23, the new playback progress of the first playing device 22 is acquired. The new playback progress of the first playing device 22 is a second delayed playback progress Dm3 of the first playing device 22. After the second delayed playback progress Dm3 is acquired, according to the settings of the synchronizing unit 2321, the second playback progress Ds leads the second delayed playback progress Dm3 by a second predetermined time period. The second predetermined time period is 3 seconds, but is not limited thereto.

Then, the synchronizing unit 2321 calculates the difference between the current second systematic time Ss1 and the first initial playback time Cm (i.e. Ss1−Cm), and calculates the difference between the second playback progress Ds and the first playback progress Dm (i.e. Ds−Dm). Consequently, under control of the synchronizing unit 2321, the audio playback of the second playing device 23 is started at the time when the second systematic time Ss is larger than or equal to the three terms. That is, the audio playback of the second playing device 23 is started at the time when Ss≧(Sm1−Cm)+(Ds−Dm)+Cm.

Meanwhile, the second operation status of the second playing device 23 is switched to the first operation status of the first playing device 22 by the synchronizing unit 2321, and the purpose of synchronizing the audio playback of the second playing device 23 with the audio playback of the first playing device 22 is achieved.

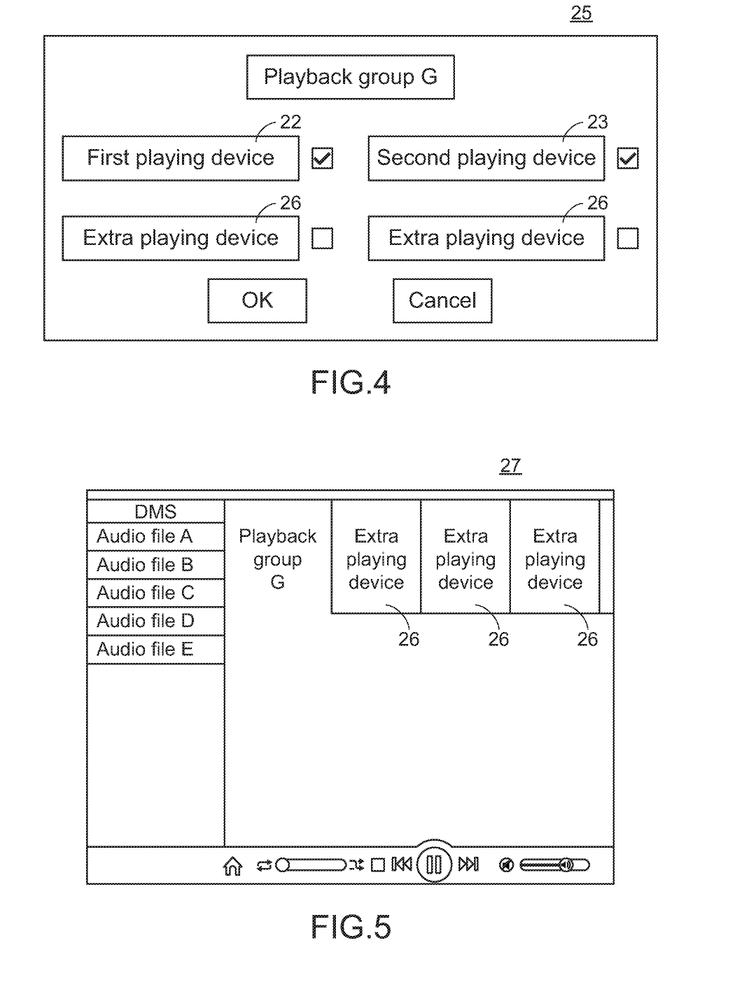

FIG. 5 is an operation interface of the digital media controller of the audio playback system according to the embodiment of the present invention. Please refer to FIGS. 2, 3 and 5. After the step (B), the user may use an operation interface 27 of the digital media controller 21 to select the digital media server (DMS) 24 and an audio file of the digital media server 24 and transmit an action command to the playback group G In response to action command, the selected audio file of the first playing device 22 and the second playing device 23 can be synchronously played (i.e. in the step (C)). It is noted that the action command from the digital media server 24 may be received by the first playing device 22 and then transmitted to the second playing device 23. Alternatively, the action command from the digital media server 24 may be received by the second playing device 23 and then transmitted to the first playing device 22.

In accordance with the present invention, the action command is a play command, a replay command or a seek command, but is not limited thereto. The contents of the operation interface 27 as shown in FIG. 5 are presented herein for purpose of illustration and description only. That is, the contents of the operation interface 27 of the present invention are not restricted.

In case that both of the first playing device 22 and the second playing device 23 are in the stop status, the user may transmit the play command to the playback group G via the operation interface 27. After the play command is received by the first playing device 22, the first time information Tm is transmitted from the first DMR control module 221 of the first playing device 22 to the synchronizing unit 2321 of the second playing device 23 (i.e. in the step (D)).

Meanwhile, the first DMR control module 221 acquires at least one audio data of the audio file from the digital media server 24 and transmits the at least one audio data to the second DMC control module 232 of the second playing device 23 in the wireless transmission manner.

Then, the first time information Tm and the second time information Ts stored in the second playing device 23 are compared with each other by the synchronizing unit 2321 of the second playing device 23. According to the comparing result, the first audio data of the audio file is controlled to be played by the second playing device 23 and the first playing device 22 in response to the play command (i.e. in the step (E)). The detailed procedure of the step (E) will be illustrated as follows.

In particular, after the play command is received by the first playing device 22, the audio file is not immediately played by the first playing device 22. The reason is that it takes time to transmit the first time information Tm to the second playing device 23 and it also takes a certain processing time after the first time information Tm is received by the second playing device 23. Consequently, the first DMR control module 221 of the first playing device 22 will control the audio playback of the audio file of the first playing device 22 to be started at a time after the first time information Tm has been transmitted by the first playing device 22 for the delay time interval Td.

The scheduled playback time Pm is a time after the current first systematic time Sm1 is transmitted for the delay time interval Td, and the current first systematic time Sm1 is the time corresponding to the first time information Tm. As mentioned above, the delay time interval Td is 10 seconds. In case that the current first systematic time Sm1 when the first time information Tm is transmitted is 1 hour 1 minute 1 second, the first systematic time Sm corresponding to the first scheduled playback time Pm is the current first systematic time Sm1 after 10 seconds (i.e. 1 hour 1 minute 11 second).

For synchronously starting the audio playback of the first playing device 22 and the second playing device 23, the second playing device 23 has to start the audio playback at the time when the second systematic time Ss is equal to the first scheduled playback time Pm. However, if the network connection is unstable or some reasons occur, the second playing device 23 fails to start the audio playback just at the time when the second systematic time Ss is equal to the first scheduled playback time Pm. For avoiding suspension of the second playing device 23, under control of the synchronizing unit 2321, the playback of first audio data of the audio file is started by the second playing device 23 at the time when the second systematic time Ss is larger than or equal to the first scheduled playback time Pm (i.e. Ss≧Pm).

In case that both of the first playing device 22 and the second playing device 23 are in the pause status, the user may transmit the replay command to the playback group G via the operation interface 27 of the digital media controller 21 as shown in FIG. 5 (i.e. in the step (C) of FIG. 3).

After the replay command is received by the first playing device 22, the first time information Tm is transmitted from the first DMR control module 221 of the first playing device 22 to the synchronizing unit 2321 of the second playing device 23 (i.e. in the step (D) of FIG. 3).

Meanwhile, the first DMR control module 221 acquires at least one audio data of the audio file from the digital media server 24 and transmits the at least one audio data to the second DMC control module 232 of the second playing device 23 in the wireless transmission manner.

Then, the first time information Tm and the second time information Ts stored in the second playing device 23 are compared with each other by the synchronizing unit 2321 of the second playing device 23. According to the comparing result, the first audio data of the audio file is controlled to be played by the second playing device 23 and the first playing device 22 in response to the play command (i.e. in the step (E)). The detailed procedure of the step (E) will be illustrated as follows.

In particular, after the first time information Tm is received by the synchronizing unit 2321, the synchronizing unit 2321 calculates the difference between the second playback progress Ds and the first playback progress Dm (i.e. Ds−Dm). According to the difference (Ds−Dm), the synchronizing unit 2321 may judge whether the time length of the audio file having been played by the first playing device 22 and he time length of the audio file having been played by the second playing device 23 are identical when the first playing device 22 and the second playing device 23 are in the pause status.

For example, if the first playback progress Dm indicating the time length of the audio file having been played is 1 minute and 10 seconds and the second playback progress Ds indicating the time length of the audio file having been played is 1 minute and 11 seconds, the difference (Ds−Dm) is 1. Under control of the synchronizing unit 2321, the timing of starting the audio playback of the second playing device 23 lags the timing of starting the audio playback of the first playing device 22 by 1 second. As a consequence, the audio playback of the second playing device 23 can be synchronized with the audio playback of the first playing device 22.

As mentioned above, the audio playback of the first playing device 22 will be started at the first scheduled playback time Pm (i.e. Pm=Sm1+Td). Under control of the synchronizing unit 2321, the playback of first audio data of the audio file is started by the second playing device 23 at the time when the second systematic time Ss is larger than or equal to the sum of the first scheduled playback time Pm and the difference between the second playback progress Ds and the first playback progress Dm (i.e. Ss≧(Ds−Dm)+Pm).

In case that both of the first playing device 22 and the second playing device 23 are in the play status, the user may transmit the seek command to the playback group G via the operation interface 27 of the digital media controller 21 as shown in FIG. 5 (i.e. in the step (C) of FIG. 3).

After the seek command is received by the first playing device 22, the first time information Tm is transmitted from the first DMR control module 221 of the first playing device 22 to the synchronizing unit 2321 of the second playing device 23 (i.e. in the step (D) of FIG. 3). Meanwhile, the first DMR control module 221 acquires at least one audio data of the audio file from the digital media server 24 and transmits the at least one audio data to the second DMC control module 232 of the second playing device 23 in the wireless transmission manner.

Then, the first time information Tm and the second time information Ts stored in the second playing device 23 are compared with each other by the synchronizing unit 2321 of the second playing device 23. According to the comparing result, the first audio data of the audio file is controlled to be played by the second playing device 23 and the first playing device 22 in response to the seek command (i.e. in the step (E)). The detailed procedure of the step (E) will be illustrated as follows.

In response to the seek command, the playback progresses of the first playing device 22 and the second playing device 23 are correspondingly changed. For example, if the time length of the audio file having been played by the first playing device 22 and the second playing device 23 is 1 minute and 1 second, the user may move a progress bar or employ any other appropriate way to immediately start the audio playback of the first playing device 22 and the second playing device 23 at another time point (e.g. at the time point corresponding to the playback progress of 3 minute and 0 second).

Consequently, after the seek command is received by the first DMR control module 221, the first playback progress Dm should be reset to a new playback progress corresponding to the time point designated by the user. Moreover, after the seek command is received by the synchronizing unit 2321, the second playback progress Ds should be reset to a new playback progress corresponding to the time point designated by the user.

As mentioned above, the audio playback of the first playing device 22 will be started at the first scheduled playback time Pm (i.e. Pm=Sm1+Td). That is, the audio playback of the first playing device 22 is started from the reset first playback progress Dm at the first scheduled playback time Pm. Moreover, when the seek command is received by the first playing device 22 and the second playing device 23, there is no error between the reset first playback progress Dm and the reset second playback progress Ds. Consequently, under control of the synchronizing unit 2321, the audio playback of the second playing device 23 is started from the reset second playback progress Ds at the time when the second systematic time Ss is larger than or equal to the first scheduled playback time Pm (i.e. Ss≧(Ds−Dm)+Pm).

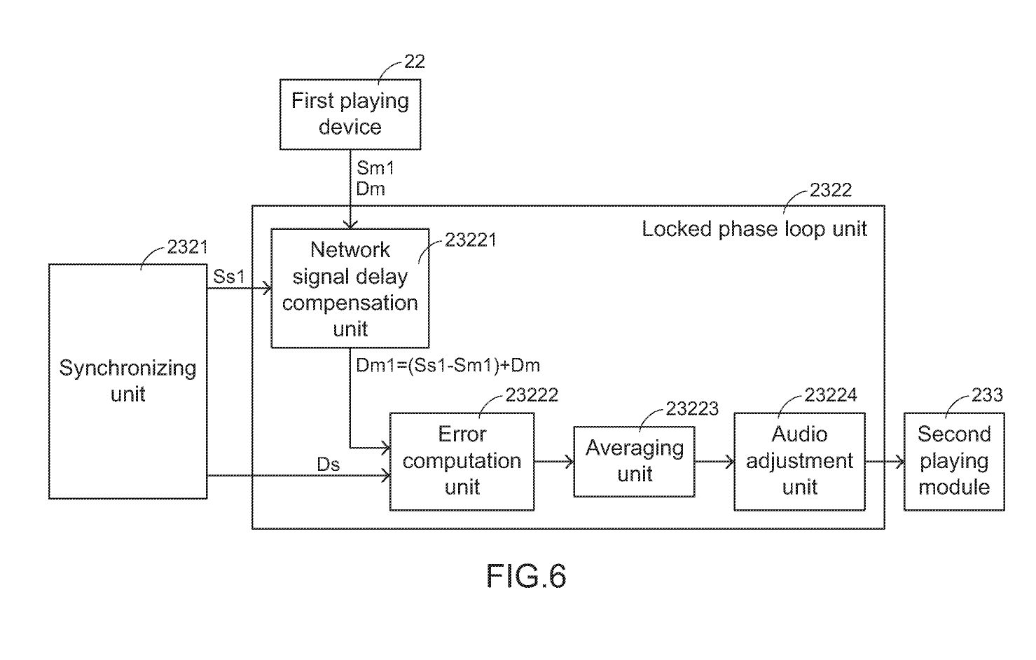

FIG. 6 is a schematic functional block diagram illustrating a locked phase loop unit of the second playing device of the audio playback system according to the embodiment of the present invention. Please refer to FIGS. 2, 3 and 6. After the step (E), both of the first playing device 22 and the second playing device 23 start the audio playback, and the locked phase loop unit 2322 of the second playing device 23 performs the step (F). In the step (F), the second playing device 23 continuously receives the first time information Tm of the first playing device 22 and compares the first time information Tm with the second time information Ts so as to adjust the playback progress of the second playing device 23. Consequently, the audio playback of the second playing device 23 can be synchronized with the audio playback of the first playing device 22.

In particular, a network signal delay compensation unit 23221 of the locked phase loop unit 2322 may periodically acquire the current first systematic time Sm1 and the first playback progress Dm of the first playing device 22 from the first DMR control module 221 in every fixed time interval. For example, the fixed time interval is 1 second, but is not limited thereto.

Generally, it takes a transmission time for the second playing device 23 to receive the current first systematic time Sm1 and the first playback progress Dm. That is, when the first playback progress Dm is received by the second playing device 23, the new playback progress of the first playing device 22 leads the first playback progress Dm. Consequently, the network signal delay compensation unit 23221 has to calculate the new playback progress of the first playing device 22 corresponding to the time point when the current first systematic time Sm1 and the first playback progress Dm are received. The way of calculating the new playback progress will be illustrated in more details as follows.

Firstly, the difference between the current second systematic time Ss1 when the first time information Tm is received and the current first systematic time Sm1 when the first time information Tm is transmitted (i.e. Ss1−Sm1) is calculated by the network signal delay compensation unit 23221. Consequently, the time period of transmitting the first time information Tm is acquired.

Then, the sum of the difference (Ss1−Sm1) and the first playback progress Dm, i.e. (Ss1−Sm1)+Dm, is calculated by the network signal delay compensation unit 23221. Consequently, the new playback progress of the first playing device 22 corresponding to the time point when the current first systematic time Sm1 and the first playback progress Dm are received by the first playing device 22 is acquired. The new playback progress of the first playing device 22 is a third delayed playback progress Dm1 of the first playing device 22.

Next, an error computation unit 23222 of the locked phase loop unit 2322 calculates the difference between the second playback progress Ds corresponding to the time point of receiving the first time information Tm and the third delayed playback progress Dm1 (i.e. Ds−Dm1). Consequently, an audio playback time difference between the first playing device 22 and the second playing device 23 is acquired.

The audio playback time difference may be used to judge whether the audio playback of the first playing device 22 and the audio playback of the second playing device 23 are synchronized with each other. For example, if the audio playback time difference is 1 second, it means that the playback progress of the second playing device 23 leads the playback progress of the first playing device 22 by 1 second. Whereas, if the audio playback time difference is −1 second, it means that the playback progress of the second playing device 23 lags the playback progress of the first playing device 22 by 1 second.

As mentioned above, the network signal delay compensation unit 23221 periodically acquires the current first systematic time Sm1 and the first playback progress Dm of the first playing device 22 from the first DMR control module 221 in every fixed time interval. Consequently, after the above procedures are repeatedly done by the network signal delay compensation unit 23221 and the error computation unit 23222, plural audio playback time differences at different time points are acquired.

Whenever the audio playback time difference is calculated, the playback progress of the second playing device 23 is not immediately adjusted by the error computation unit 23222. On the other hand, the audio playback time difference is firstly transmitted to an averaging unit 23223 of the locked phase loop unit 2322. The reason is that each audio playback time difference is very small or even near zero. In case that the audio playback time difference is very small, the asynchronization between the second playing device 23 and the first playing device 22 cannot be recognized by the human hearing. Under this circumstance, it is not necessary to adjust the playback progress according to the signal audio playback time difference.

After the plural audio playback time differences (e.g. 100 audio playback time differences) are acquired, the averaging unit 23223 calculates an average value of the plural audio playback time differences, thereby acquiring an average time difference value.

Since the sampling rates, the bit depths and the channel numbers of different audio file are different, the bit numbers of the audio data that can be played by the first playing device 22 and the second playing device 23 in one second are distinguished. For example, in case that the audio file is a WAV file with a 44,100 Hz sampling rate, a 16-bit depth and two channels, the audio data bit number generated in a second is equal to 1,411,200 bits. That is, 16 (bits)×2 (channels)×44,100 (sampling rate)=1,411,200.

Consequently, by an audio adjustment unit 23224 of the locked phase loop unit 2322, the audio data bit number to be adjusted by the second playing device 23 may be realized according to the average time difference value, and the audio playback of the second playing device 23 may be controlled according to the audio data bit number. For example, if the average time difference value is 1 second, i.e. the playback progress of the second playing device 23 leads the first playing device 22 by 1 second, the audio adjustment unit 23224 may control the first playing device 22 to play a 1,411,200-bit blank data. Whereas, if the average time difference value is −1 second, i.e. the playback progress of the second playing device 23 lags the first playing device 22 by 1 second, the audio adjustment unit 23224 may control the first playing device 22 to skip a 1,411,200-bit audio data and directly play a next audio data. It is noted that the above two approaches are effective to synchronize the audio playback of the second playing device 23 with the audio playback of the first playing device 22.

However, if the audio playback time difference is too large, for preventing the adjusting action of the audio adjustment unit 23224 from being recognized by the human hearing, the adjusting action of the audio adjustment unit 23224 may be performed in several stages and a portion of the bits of the audio data may be processed in each stage.

In the above embodiment, after the synchronizing unit 2321 compares the first time information Tm with the second time information Ts, the second playing device 23 and the first playing device 22 start the audio playback according to the comparing result. During the audio playback, the locked phase loop unit 2322 continuously calculates the audio playback time difference between the first playing device 22 and the second playing device 23, and adjusts the playback progress of the second playing device 23. Consequently, the audio playback of the second playing device 23 can be effectively synchronized with the audio playback of the first playing device 22. From the above descriptions, the method and the audio playback system can avoid the asynchronization between the plural playing devices that is caused by transmission distance, transmission speed, network stability or other factors.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for synchronizing audio playback of plural playing devices, the plural playing devices comprise a first playing device and a second playing device, the method comprising steps of:
(A) setting the first playing device as a master playing device, wherein the first playing device is in a first operation status, and the second playing device is in a second operation status;
(B) allowing the first playing device to transmit the first operation status to the second playing device, so that the second operation status of the second playing device is switched to the first operation status;
(C) using a digital media controller to transmit an action command;
(D) transmitting a first time information of the first playing device to the second playing device after the playback command is received by the first playing device;
(E) the second playing device comparing the first time information of the first playing device with a second time information of the second playing device, thereby controlling the second playing device and the first playing device to start the audio playback in response to the action command; and
(F) allowing the second playing device to continuously receive the first time information of the first playing device and compare the first time information with the second time information after the first playing device and the second playing device start the audio playback, so that a playback progress of the second playing device is adjusted and the audio playback of the second playing device is synchronized with the audio playback of the first playing device.

2. The method according to claim 1, wherein the step (A) further comprises a sub-step of using the digital media controller to set a playback group including the first playing device and the second playing device.

3. The method according to claim 2, wherein after the playback group including the first playing device and the second playing device is set, the step (A) further comprises a sub-step of synchronizing a first systematic time of the first playing device and a second systematic time of the second playing devices.

4. The method according to claim 2, wherein the step (A) further comprises a sub-step of transmitting a delay time interval of the playback group from the digital media controller to the first playing device.

5. The method according to claim 1, wherein the step (A) further comprises a sub-step of transmitting a playback group information from the first playing device to the second playing device.

6. The method according to claim 1, wherein in the step (B) or the step (D), the first playing device acquires at least one audio data of an audio file from a digital media server and transmits the at least one audio data of the audio file to the second playing device in the wireless transmission manner.

7. The method according to claim 1, wherein the first time information contains at least one of a current first systematic time Sm1, a first scheduled playback time Pm, a first playback progress Dm and a first initial playback time Cm, and the second time information contains at least one of a current second systematic time Ss1, a second scheduled playback time Ps, a second playback progress Ds and a second initial playback time Cs, wherein the current first systematic time Sm1 is a first systematic time Sm when the first time information is transmitted, the current second systematic time Ss1 is a second systematic time Ss when the first time information Tm is received, the first scheduled playback time Pm is the first systematic time Sm when scheduled playback of an audio file is started by the first playing device, the second scheduled playback time Ps is the second systematic time Ss when the scheduled playback of the audio file is started by the second playing device, the first playback progress Dm indicates a time length of the audio file having been played by the first playing device, the second playback progress Ds indicates the time length of the audio file having been played by the second playing device, the first initial playback time Cm is the first systematic time Sm when the audio file is started to be played by the first playing device at a first time, and the second initial playback time Cs is the second systematic time Ss when the audio file is started to be played by the second playing device at a first time.

8. The method according to claim 7, wherein in the step (B), the first operation status is a stop status, a pause status or a play status.

9. The method according to claim 8, wherein the first operation status is the pause status, and the step (B) comprises sub-steps of:
(B1) allowing the first playing device to transmit the first operation status and the first playback progress Dm to the second playing device; and
(B2) switching the second operation status of the second playing device to the pause status, wherein the second playback progress Ds leads the first playback progress Dm by a first predetermined time period according to settings.

10. The method according to claim 8, wherein the first operation status is the play status, and the step (B) comprises sub-steps of:
(B3) allowing the first playing device to transmit the first operation status, the first playback progress Dm, the first initial playback time Cm and the current first systematic time Sm1 to the second playing device;
(B4) judging whether a sum of the first playback progress Dm and the first initial playback time Cm is equal to the current first systematic time Sm1, wherein if the judging condition is satisfied, a sub-step (B5) is performed, wherein if the judging condition is not satisfied, a sub-step (B6) is performed;
(B5) allowing the second playing device to calculate a difference between the current second systematic time Ss1 and the first initial playback time Cm so as to acquire a first delayed playback progress of the first playing device, and then to perform a sub-step (B7) and a sub-step (B8);
(B6) allowing the second playing device to calculate a difference between the current second systematic time Ss1 and the current first systematic time Sm1 and calculate a sum of the difference (Ss1−Sm1) and the first playback progress Dm so as to acquire a second delayed playback progress of the first playing device, and then to perform the sub-step (B7) and the sub-step (B8);
(B7) allowing the second playback progress Ds to lead the first delayed playback progress or the second delayed playback progress by a second predetermined time period according to settings of the second playing device; and
(B8) allowing the second playing device to calculate a difference between the current second systematic time Ss1 and the first initial playback time Cm and a difference between the second playback progress Ds and the first playback progress Dm, and control the audio playback of the second playing device to be started at a time when the second systematic time Ss is larger than or equal to a sum of the difference (Sm1−Cm), the difference (Ds−Dm) and the first initial playback time Cm, so that the second operation status is switched to the play status.

11. The method according to claim 7, wherein the action command is a play command, and the step (E) comprises a sub-step of: (E1) controlling the audio playback of the second playing device to be started at a time when the second systematic time Ss is larger than or equal to the first scheduled playback time Pm, wherein the first scheduled playback time Pm is equal to a sum of the current first systematic time Sm1 and a delay time interval, and the audio playback of the second playing device is started at the first scheduled playback time Pm.

12. The method according to claim 7, wherein the action command is a replay command, and the step (E) comprises sub-steps of:
(E2) calculating a difference between the second playback progress Ds and the first playback progress Dm; and
(E3) controlling the audio playback of the second playing device to be started at a time when the second systematic time Ss is larger than or equal to a sum of the first scheduled playback time Pm and the difference (Ds−Dm), wherein the first scheduled playback time Pm is equal to a sum of the current first systematic time Sm1 and a delay time interval, and the audio playback of the second playing device is started at the first scheduled playback time Pm.

13. The method according to claim 7, wherein the action command is a seek command, and the step (E) comprises sub-steps of:
(E4) resetting the first playback progress Dm of the first playing device and the second playback progress Ds of the second playing device in response to the seek command, and
(E5) controlling the audio playback of the second playing device to be started at a time when the second systematic time Ss is larger than or equal to the first scheduled playback time Pm, wherein the first scheduled playback time Pm is equal to a sum of the current first systematic time Sm1 and a delay time interval, and the audio playback of the second playing device is started at the first scheduled playback time Pm.

14. The method according to claim 7, wherein the step (F) comprises sub-steps of:
(F1) transmitting the current first systematic time Sm1 and the first playback progress Dm from the first playing device to the second playing device;
(F2) allowing the second playing device to calculate a difference between the current first systematic time Sm1 and the first playback progress Dm and calculate a sum of the difference (Ss1−Sm1) and the first playback progress Dm, thereby acquiring a third delayed playback progress of the first playing device;
(F3) allowing the second playing device to calculate a difference between the second playback progress Ds and the third delayed playback progress, thereby acquiring an audio playback time difference;
(F4) repeatedly performing the steps (F1), (F2) and (F3) to acquire plural audio playback time differences, and calculating an average time difference value of the plural audio playback time differences; and
(F5) allowing the second playing device to convert the average time difference value into an audio data bit number to be adjusted; and
(F6) allowing the second playing device to control the audio playback of the second playing device according to the audio data bit number.

15. An audio playback system comprises:
a digital media controller setting a first playing device as a master playing device and issuing an action command;
the first playing device comprising a first digital media renderer control module and a first digital media controller control module, wherein a first operation status and a first time information of the first playing device are transmitted from the first digital media renderer control module to a second playing device; and
the second playing device comprising a second digital media renderer control module and a second digital media controller control module, wherein the second digital media controller control module comprises:
a synchronizing unit receiving the first operation status of the first playing device and switching a second operation status of the second playing device into the first operation status, and comparing the first time information of the first playing device with a second time information of the second playing device, thereby controlling audio playback of the first playing device and audio playback of the second playing device to be synchronously started in response to an action command; and
a locked phase loop unit continuously receiving the first time information of the first playing device and comparing the first time information with the second time information after the first playing device and the second playing device start the audio playback, so that a playback progress of the second playing device is adjusted and the audio playback of the second playing device is synchronized with the audio playback of the first playing device.

16. The audio playback system according to claim 15, wherein the digital media controller is further used to set a playback group including the first playing device and the second playing device.

17. The audio playback system according to claim 16, wherein a delay time interval of the playback group is transmitted from the digital media controller to the first digital media renderer control module of the first playing device.

18. The audio playback system according to claim 15, wherein a playback group information is transmitted from the first digital media renderer control module of the first playing device to the second digital media controller control module of the second playing device.

19. The audio playback system according to claim 15, wherein the first digital media renderer control module of the first playing device acquires at least one audio data of an audio file from a digital media server and transmits the at least one audio data of the audio file to the second digital media controller control module of the second playing device in the wireless transmission manner.

20. The audio playback system according to claim 15, wherein the first time information contains at least one of a current first systematic time Sm1, a first scheduled playback time Pm, a first playback progress Dm and a first initial playback time Cm, and the second time information contains at least one of a current second systematic time Ss1, a second scheduled playback time Ps, a second playback progress Ds and a second initial playback time Cs, wherein the current first systematic time Sm1 is a first systematic time Sm when the first time information is transmitted, the current second systematic time Ss1 is a second systematic time Ss when the first time information Tm is received, the first scheduled playback time Pm is the first systematic time Sm when scheduled playback of a audio file is started by the first playing device, the second scheduled playback time Ps is the second systematic time Ss when the scheduled playback of the audio file is started by the second playing device, the first playback progress Dm indicates a time length of the audio file having been played by the first playing device, the second playback progress Ds indicates the time length of the audio file having been played by the second playing device, the first initial playback time Cm is the first systematic time Sm when the audio file is started to be played by the first playing device at a first time, and the second initial playback time Cs is the second systematic time Ss when the audio file is started to be played by the second playing device at a first time.

21. The audio playback system according to claim 20, wherein the first operation status is a stop status, a pause status or a play status.

22. The audio playback system according to claim 21, wherein if the first operation status is the pause status, the first operation status and the first playback progress Dm are transmitted from the first digital media renderer control module of the first playing device to the synchronizing unit of the second playing device, and the second operation status is switched to the pause status by the synchronizing unit, wherein the second playback progress Ds leads the first playback progress Dm by a first predetermined time period according to settings of the synchronizing unit.

23. The audio playback system according to claim 21, wherein if the first operation status is the play status, the first operation status, the first playback progress Dm, the first initial playback time Cm and the current first systematic time Sm1 are transmitted from the first digital media renderer control module of the first playing device to the synchronizing unit of the second digital media controller control module of the second playing device, and the synchronizing unit judges whether a sum of the first playback progress Dm and the first initial playback time Cm is equal to the current first systematic time Sm1, wherein if the sum of the first playback progress Dm and the first initial playback time Cm is equal to the current first systematic time Sm1, the synchronizing unit calculates a difference between the current second systematic time Ss1 and the first initial playback time Cm so as to acquire a first delayed playback progress of the first playing device, wherein if the sum of the first playback progress Dm and the first initial playback time Cm is not equal to the current first systematic time Sm1, the synchronizing unit calculates a difference between the current second systematic time Ss1 and the current first systematic time Sm1 and calculates a sum of the difference (Ss1−Sm1) and the first playback progress Dm so as to acquire a second delayed playback progress of the first playing device, wherein the second playback progress Ds leads the first delayed playback progress or the second delayed playback progress by a second predetermined time period according to settings of the synchronizing unit, wherein the synchronizing unit calculates a difference between the current second systematic time Ss1 and the first initial playback time Cm and a difference between the second playback progress Ds and the first playback progress Dm and controls the audio playback of the second playing device to be started at a time when the second systematic time Ss is larger than or equal to a sum of the difference (Sm1−Cm), the difference (Ds−Dm) and the first initial playback time Cm, so that the second operation status is switched to the play status.

24. The audio playback system according to claim 20, wherein the action command is a play command, wherein the synchronizing unit of the second digital media controller control module controls the audio playback of the second playing device to be started at a time when the second systematic time Ss is larger than or equal to the first scheduled playback time Pm, wherein the first scheduled playback time Pm is equal to a sum of the current first systematic time Sm1 and a delay time interval, and the audio playback of the second playing device is started at the first scheduled playback time Pm.

25. The audio playback system according to claim 20, wherein the action command is a replay command, wherein the synchronizing unit of the second digital media controller control module calculates a difference between the second playback progress Ds and the first playback progress Dm and controls the audio playback of the second playing device to be started at a time when the second systematic time Ss is larger than or equal to a sum of the first scheduled playback time Pm and the difference (Ds−Dm), wherein the first scheduled playback time Pm is equal to a sum of the current first systematic time Sm1 and a delay time interval, and the audio playback of the second playing device is started at the first scheduled playback time Pm.

26. The audio playback system according to claim 20, wherein the action command is a seek command, wherein the first digital media renderer control module resets the first playback progress Dm and the synchronizing unit of the second digital media controller control module resets the second playback progress Ds in response to the seek command, and the synchronizing unit controls the audio playback of the second playing device to be started at a time when the second systematic time Ss is larger than or equal to the first scheduled playback time Pm, wherein the first scheduled playback time Pm is equal to a sum of the current first systematic time Sm1 and a delay time interval, and the audio playback of the second playing device is started at the first scheduled playback time Pm.

27. The audio playback system according to claim 20, wherein the locked phase loop unit comprises:
a network signal delay compensation unit receiving the current first systematic time Sm1 and the first playback progress Dm from the first digital media renderer control module, and acquiring a third delayed playback progress of the first playing device according to a difference between the current second systematic time Ss1 and the current first systematic time Sm1 and according to a sum of the difference (Ss1−Sm1) and the first playback progress Dm;
an error computation unit acquiring an audio playback time difference according to a difference between the second playback progress Ds and the third delayed playback progress;
an averaging unit receiving plural audio playback time differences, and calculating an average time difference value of the plural audio playback time differences; and
an audio adjustment converting the average time difference value into an audio data bit number and controlling the audio playback of the second playing device according to the audio data bit number.
